(19) United States
(12) Patent Application Publication
(10) Pub. No.: US 2012/0050331 A1
(43) Pub. Date: Mar. 1, 2012

(54) Display Device, Information Terminal Device, and Display Method

(76) Inventor: Tomohiro Kanda, Saitama (JP)

(21) Appl. No.: 13/069,073

(22) Filed: Mar. 22, 2011

(30) Foreign Application Priority Data
Aug. 27, 2010 (JP) 2010-190937

(51) Int. Cl. G09G 5/00

(52) U.S. Cl. 345/649

(57) ABSTRACT

According to one embodiment, a display device includes a receiver, an image rotating module, and a display module. The receiver is configured to receive display data and orientation information from an external device connected to the display device. The display data includes a display screen to be displayed in an orientation according to an orientation of the external device. The orientation information indicates the orientation of the external device. The image rotating module is configured to rotate the display screen contained in the display data in a direction toward which the display screen is adapted to the orientation of the external device based on the orientation information. The display module is configured to display the display screen rotated by the image rotating module.

### CROSS-REFERENCE TO RELATED APPLICATIONS

This application is based upon and claims the benefit of priority from Japanese Patent Application No. 2010-190937, filed on Aug. 27, 2010, the entire contents of which are incorporated herein by reference.

### FIELD

Embodiments described herein relate generally to a display device, an information terminal device, and a display method.

### BACKGROUND

Conventionally, there exists information terminal devices, such as a mobile phone, that can be connected to a display device, such as a television (TV) to output a display screen thereof to the display device. The display device displays a display screen output from such an information terminal device being connected thereto. Accordingly, a user can check the display screen of the information terminal device not only by the information terminal device, but also by a display of the display device.

Some of such information terminal devices detect an orientation thereof such as vertical orientation or horizontal orientation, and changes the display screen in accordance with the detected orientation. In the conventional technique, according to the change in the orientation of the information terminal device, the upright orientation of the display screen of the information terminal device displayed on the display of the display device becomes the sideway orientation. As a result, it sometimes becomes difficult to see the display screen output from the information terminal device.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary conceptual diagram illustrating connection between a television (TV) receiver and a mobile phone according to an embodiment;

FIG. 2 is an exemplary external front view of the mobile phone placed in a cradle in the embodiment;

FIG. 3 is an exemplary external rear view of the mobile phone placed in the cradle in the embodiment;

FIG. 4 is an exemplary conceptual diagram illustrating display of the TV receiver and the mobile phone in the embodiment;

FIG. 5 is an exemplary block diagram of configurations of the TV receiver in the embodiment;

FIG. 6 is an exemplary block diagram of configurations of the mobile phone in the embodiment;

FIG. 7 is an exemplary flowchart of an operation of the TV receiver and the mobile phone in the embodiment;

FIG. 8 is an exemplary conceptual diagram illustrating an operation image in the embodiment;

FIG. 9 is an exemplary conceptual diagram illustrating further display of the TV receiver and the mobile phone in the embodiment;

FIG. 10 is an exemplary conceptual diagram illustrating still further display of the TV receiver and the mobile phone in the embodiment;

FIG. 11 is an exemplary conceptual diagram illustrating still further display of the TV receiver and the mobile phone in the embodiment;

FIG. 12 an exemplary conceptual diagram illustrating display of a TV receiver and a mobile phone according to a modification of the embodiment; and

FIG. 13 is an exemplary conceptual diagram illustrating further display of the TV receiver and the mobile phone in the modification.

### DETAILED DESCRIPTION

In general, according to one embodiment, a display device comprises a receiver, an image rotating module, and a display module. The receiver is configured to receive display data and orientation information from an external device connected to the display device. The display data comprises a display screen to be displayed in an orientation according to an orientation of the external device. The orientation information indicates the orientation of the external device. The image rotating module is configured to rotate the display screen contained in the display data in a direction toward which the display screen is adapted to the orientation of the external device based on the orientation information. The display module is configured to display the display screen rotated by the image rotating module.

In the following, a display device, an information terminal device, and a display method according to an embodiment are explained in detail with reference to the attached drawings. In the embodiment, a television (TV) receiver and a mobile phone are explained as the display device and the information terminal device, respectively. However, other than the TV receiver and the mobile phone, the display device and the information terminal device may be an information device such as a personal computer (PC), a notebook PC, a personal digital assistant (PDA), and/or the like.

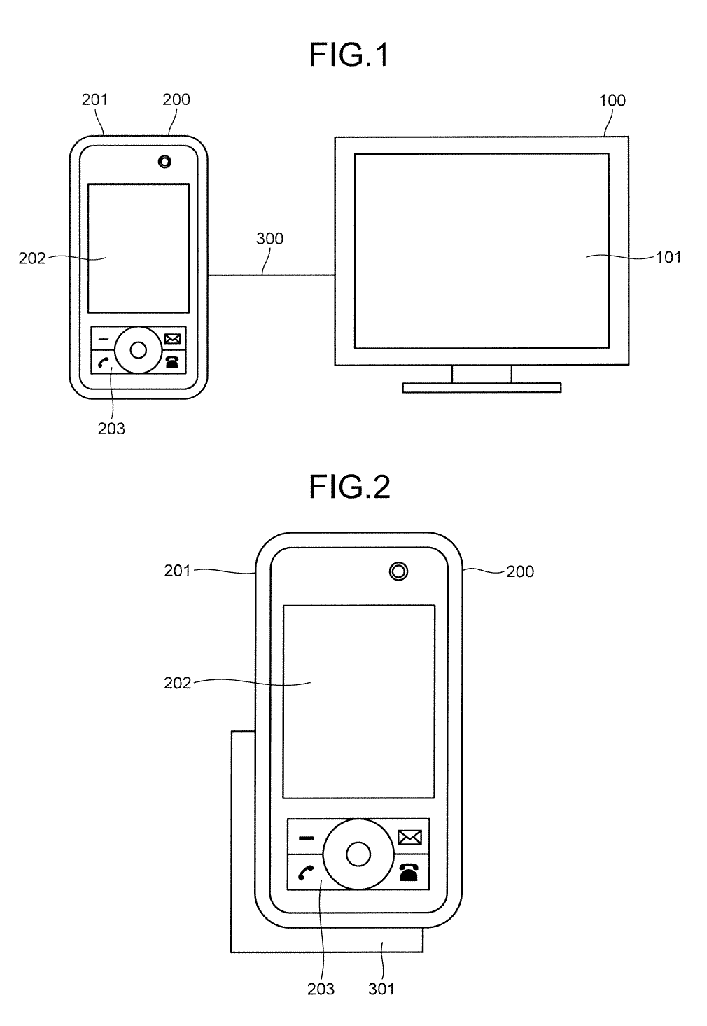

FIG. 1 is a conceptual diagram illustrating a connection between a TV receiver 100 and a mobile phone 200. As illustrated in FIG. 1, the TV receiver 100 and the mobile phone 200 are connected to each other via a communication cable 300 so that the TV receiver 100 and the mobile phone 200 can communicate with each other. The TV receiver 100 comprises a display 101 such as a liquid crystal display (LCD). The mobile phone 200 comprises: a display 202, such as an LCD, on a front surface of a housing 201; and an operation module 203 to which various operation keys are provided. The operation module may comprise a touch panel laminated on the display 202.

The communication cable 300 comprises cables such as a video and audio signal line for transferring a video signal and an audio signal and a control signal line for transferring a control signal, not illustrated. The communication cable 300 complies for example with high-definition multimedia interface (HDMI) standard. The TV receiver 100 and the mobile phone 200 can communicate with each other through the communication cable 300 to transfer the video signal, the audio signal, and the control signal. In the embodiment, it is assumed that the communication cable 300 complies with the HDMI standard, and the control signal transferred between the TV receiver 100 and the mobile phone 200 complies with a control protocol referred to as HDMI-consumer electronics control (HDMI-CEC). However, the communication between the TV receiver 100 and the mobile phone 200 is not limited thereto. That is to say, a standard other than the HDMI standard may be used, and the communication between the TV receiver 100 and the mobile phone 200 may be a wireless communication complying with a wireless HD standard.

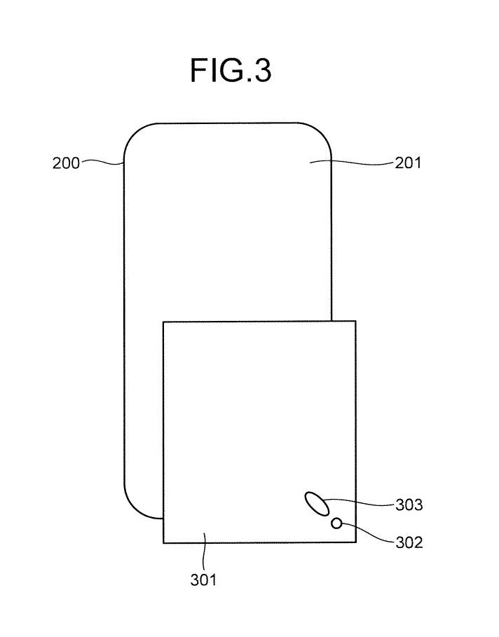

FIG. 2 is an external front view of the mobile phone 200 placed in a cradle 301. FIG. 3 is an external rear view of the mobile phone 200 placed in the cradle 301. As illustrated in FIGS. 2 and 3, the mobile phone 200 can be used while placed in the cradle 301. The mobile phone 200 and the cradle 301 are electrically connected to each other via a connector, not illustrated, provided at a rear face of the housing 201. The mobile phone 200 is connected to the communication cable 300 via an external output connector 303 provided on the rear face of the cradle 301, while the mobile phone 200 is placed in the cradle 301. Furthermore, power is supplied to the mobile phone 200 through a power connector 302 while the mobile phone 200 is placed in the cradle 301. The cradle 301 supports the housing 201 of the mobile phone 200 by a rotational supporting member not illustrated. The rotational supporting member supports the housing 201 of the mobile phone 200 so as to be held a vertical or a horizontal orientation. Accordingly, while the mobile phone 200 is placed in the cradle 301, the mobile phone 200 can be used in the vertical or the horizontal orientation. Here, the communication cable 300 does not interfere with the movement of the mobile phone 200 when the orientation of the mobile phone 200 is changed between the vertical and the horizontal orientations because the communication cable 300 is connected to the cradle 301.

In the embodiment, the mobile phone 200 is placed in the cradle 301 to connect the communication cable 300 to the mobile phone 200. However, the layout of the connection between the mobile phone 200 and the communication cable 300 is not limited thereto. For example, a connector can be provided to the housing 201 of the mobile phone 200 to connect to the communication cable 300. In this case, a user can use the mobile phone 200 while holding the mobile phone 200 in the vertical or horizontal orientation.

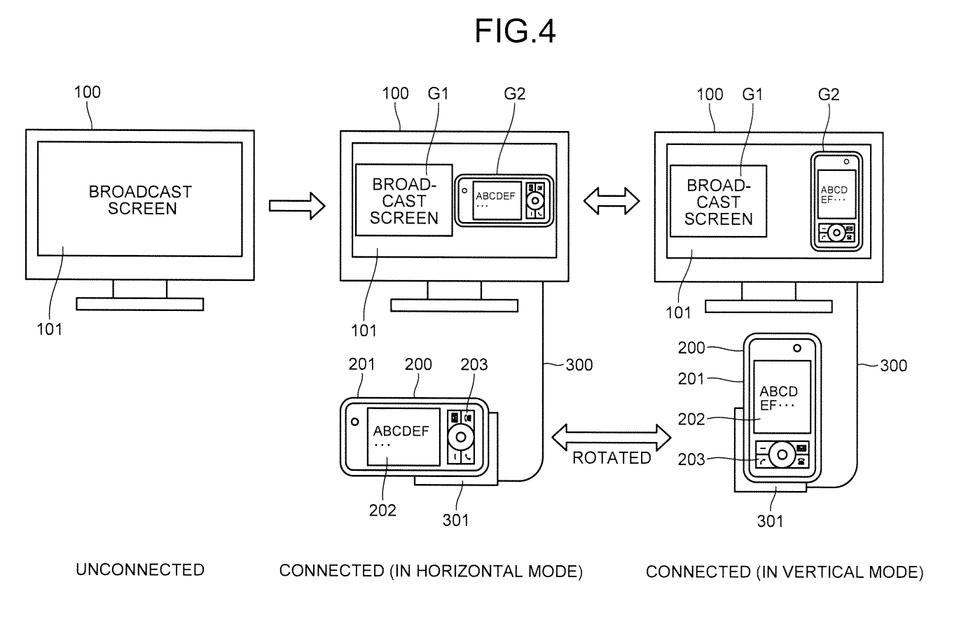

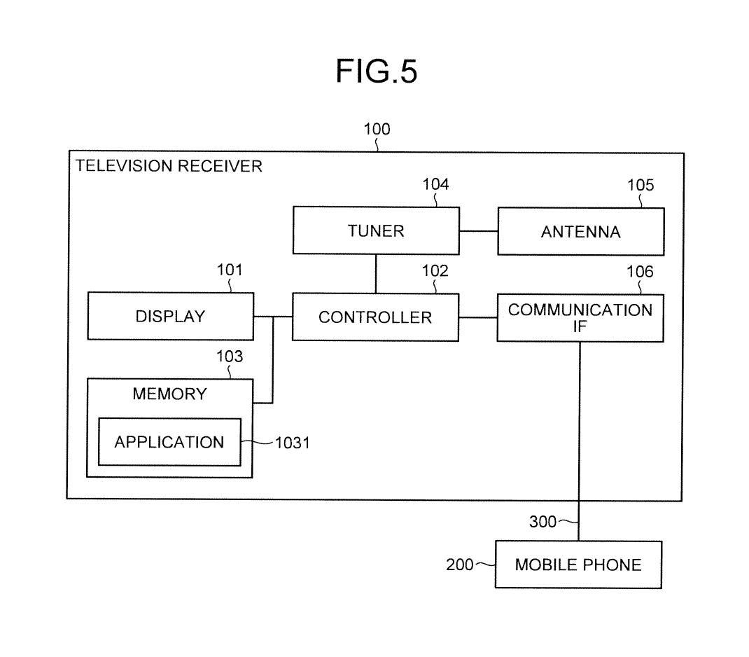

Display of the TV receiver 100 and the mobile phone 200 of the embodiment is explained. FIG. 4 is a conceptual diagram illustrating the display of the TV receiver 100 and the mobile phone 200.

As illustrated in FIG. 4, it is assumed that a received broadcast screen is displayed on the display 101 of the TV receiver 100 while the mobile phone 200 is not in connection with the TV receiver 100. When the mobile phone 200 is connected to the TV receiver 100, the display 101 of the TV receiver 100 displays a screen G1 and an external input screen G2. Here, the screen G1 displays a received display screen, and the external input screen G2 displays a display screen of the housing 201 of the mobile phone 200. In other word, the TV receiver 100 performs dual screen display of the screen G1 and the external input screen G2.

A display layout of the display screen of the mobile phone 200 is changed in accordance with an orientation of the mobile phone 200. For example, the orientation of the display is changed between vertical and horizontal orientations. By assuming for example that a display size of the display 202 of when the mobile phone 200 is held in the horizontal orientation is 480×320, a display size of the display 202 of when the mobile phone 200 is held in the vertical orientation is 320×480. In other words, the ratio between the horizontal and the vertical lengths of the display screen is changed in accordance with the orientation of the mobile phone 200.

When the display screen of the mobile phone 200 with the display layout changeable in accordance with the orientation of the mobile phone 200 is directly displayed as the external input screen G2, it becomes difficult to see the external input screen G2. This is because, in accordance with the change in the orientation of the mobile phone 200 from the vertical to the horizontal or from the horizontal to the vertical, the external input screen G2 displayed for example in the vertical orientation is changed to be displayed in the horizontal orientation. On the other hand, in the embodiment, the external input screen G2 displaying the display screen of the mobile phone 200 is rotated in accordance with the orientation of the mobile phone 200. Consequently, it becomes easier to see the external input screen G2.

Next, a configuration of the TV receiver 100 is explained. FIG. 5 is a block diagram of a configuration of the TV receiver 100. As illustrated in FIG. 5, the TV receiver 100 comprises the display 101, a controller 102, a memory 103, a tuner 104, an antenna 105, and a communication interface (IF) 106.

The controller 102 comprises for example a central processing unit (CPU), a read only memory (ROM), and a random access memory (RAM), and is configured to control operations of the TV receiver 100. In particular, the controller 102 controls each module in a manner such that the CPU loads a program stored in the ROM, an application 1031 stored in the memory 103, or the like, into the RAM, and executes them sequentially. For example, the controller 102 controls displaying content contained in broadcast wave (broadcasting program) received through the antenna 105 or the tuner 104 on the display 101, or displaying display data input via the communication IF 106 on the display 101.

The memory 103 is a memory such as a non-volatile memory storing various information required for operations of the TV receiver 100, the application 1031 to be executed by the controller 102, and/or the like. Under the control of the controller 102, the tuner 104 selects and receives a broadcast wave of a desired channel among TV broadcast waves supplied from the antenna 105. The communication IF 106 is an interface for performing data communication in accordance with a predetermined communication protocol, under the control of the controller 102. The communication IF 106 performs communication with respect to the mobile phone 200 connected via the communication cable 300, while the communication complies with the HDMI standard. The communication IF 106 detects whether the external device such as the mobile phone 200 and the TV receiver 100 are connected with each other via the communication cable 300, based on conduction state of the control signal line. When it is detected that the external device and TV receiver 100 are connected with each other, the communication IF 106 notifies the controller 102 that the external device is in connection. When the TV receiver 100 and the external device are connected to each other via the communication cable 300, data transfer starts between the TV receiver 100 and the external device.

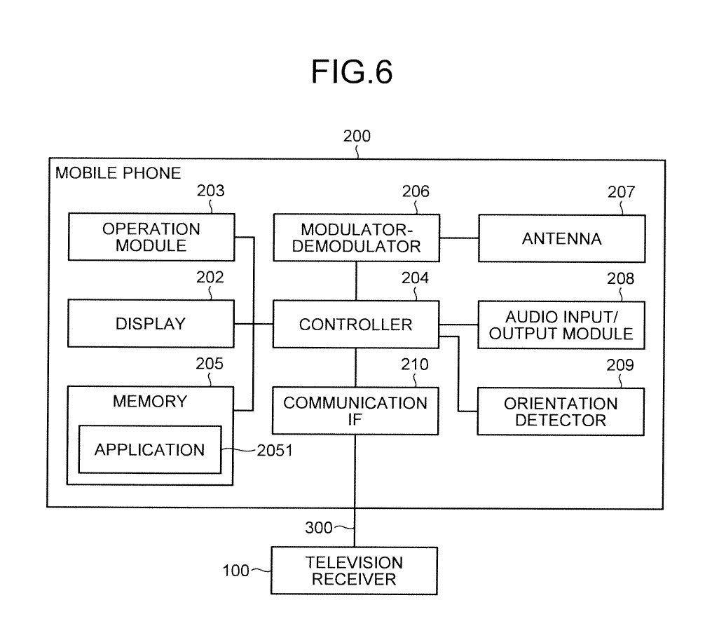

Next, a configuration of the mobile phone 200 is explained. FIG. 6 is a block diagram of a configuration of the mobile phone 200. As illustrated in FIG. 6, the mobile phone 200 comprises the display 202, the operation module 203, a controller 204, a memory 205, a modulator-demodulator 206, an antenna 207, an audio input/output module 208, an orientation detector 209, and a communication IF 210.

The controller 204 comprises a CPU, a ROM, a RAM, and/or the like not illustrated, and controls operations of the mobile phone 200. In particular, the controller 204 controls each module in a manner such that the CPU loads a program stored in the ROM, an application 2051 stored in the memory 205, and/or the like into the ROM, and executes them sequentially. For example, the controller 204 performs, for example, display control of the display 202 in accordance with the orientation of the mobile phone 200 detected by the orientation detector 209, in addition to control according to normal telephone function.

The memory 205 is a memory such as a non-volatile memory storing various information required for the operations of the mobile phone 200, the application 2051 to be executed by the controller 204, and/or the like. The modulator-demodulator 206 demodulates radio wave of a predetermined frequency received through the antenna 207, modulates information for a target of the communication in a predetermined frequency, and transmits the modulated information via the antenna 207. The antenna 207 transmits and receives radio wave within a frequency band of the mobile phone 200 (for example, 800 MHz band, 1.5 GHz band, or the like). The antenna 207 is connected to the modulator-demodulator 206. The audio input/output module 208 executes audio output process in which digital-to-analog conversion is performed on a digital audio signal and the converted digital signal is output to the speaker not illustrated, and executes audio input process in which analog-to-digital conversion is performed on an audio input from a microphone not illustrated and the converted audio input is input.

The orientation detector 209 is configured to detect an orientation of the mobile phone 200. In particular, the orientation detector 209 obtains acceleration data of the mobile phone 200 from an acceleration sensor (not illustrated) associated with directions of the XYZ axes. Then, based on the acceleration data associated with each direction of the three axes, the orientation detector 209 calculates an average of the acceleration data over a predetermined time as a three dimensional vector. Subsequently, the orientation detector 209 normalizes the calculated three dimensional vector so that the magnitude thereof becomes 1 G. Accordingly, the orientation detector 209 detects the orientation of the mobile phone 200 with reference to the direction of gravity. In the mobile phone 200, the orientation of the mobile phone 200 placed in the cradle 301 in vertical or horizontal orientation is detected based on the detection result of the orientation detector 209.

The communication IF 210 performs data communication in accordance with a predetermined communication protocol, under the control of the controller 204. The communication IF 210 comprises a connector connected to the cradle 301, and/or the like. The communication IF 210 performs communication in compliance with the HDMI standard with respect to the TV receiver 100 connected thereto via the communication cable 300. Further, based for example on the conduction state of the connector or the control signal line, the communication IF 210 detects whether the mobile phone 200 is placed in the cradle 301, or whether the external device such as the TV receiver 100 is connected to the communication IF 210 via the communication cable 300. Then, the communication IF 210 notifies the controller 204 of the detection result. Then, in response to the case when the mobile phone 200 is placed in the cradle 301, the controller 204 starts the displaying with respect to the display 202. Further, in response to the case when the TV receiver 100 and the communication IF 210 are connected with each other via the communication cable 300, the controller 204 starts the outputting with respect to the TV receiver 100, such as the display screen of the display 202.

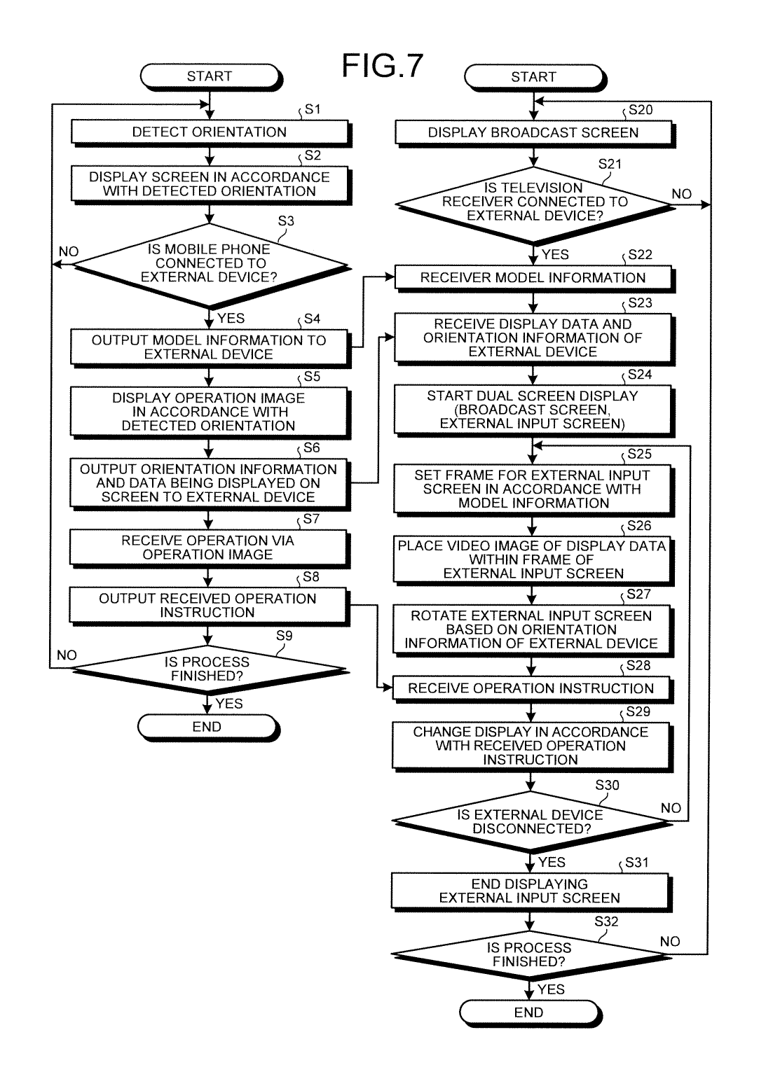

Operations of the TV receiver 100 and the mobile phone 200 are explained. FIG. 7 is a flowchart of the operations of the TV receiver 100 and the mobile phone 200.

First, the operations of the mobile phone 200 are explained. Process of the mobile phone 200 described below is realized for example when the controller 204 sequentially executes the application 2051 based on the operation instruction of the operation module 203 or based on the case when the mobile phone 200 is placed in the cradle 301.

As illustrated in FIG. 7, when the process starts, the orientation detector 209 detects the orientation of the mobile phone 200 (S1). Then, the controller 204 displays, on the display 202, the display screen corresponding to the orientation of the mobile phone 200 detected by the orientation detector 209 (S2).

In particular, assuming an orientation in which the operation module 203 is placed below the display 202 with respect to the direction of gravity as a standard orientation (vertical mode in FIG. 4), the orientation detector 209 detects whether the display 202 is oriented upward (standard orientation), rightward, leftward, or downward. Then, the controller 204 displays the display screen which is adapted to the detected orientation. For example, when the display 202 is oriented upward (vertical mode in FIG. 4), the controller 204 displays, on the display 202, a display screen in a display orientation adapted to the orientation of the mobile phone 200 in which the operation module 203 is provided at the bottom thereof. Here, the display screen is displayed with a display layout adapted to the vertically long screen size. On the other hand, when the mobile phone 200 is rotated 90 degrees toward left from the upward orientation (rotated to the horizontal mode in FIG. 4) so that the display 202 is oriented rightward with respect to the standard orientation, the controller 204 displays the display screen in a display orientation adapted to the orientation of the mobile phone 200 in which the operation module 203 is provided at the right thereof. Here, the display screen is displayed with a display layout adapted to the horizontally long screen size.

Next, the controller 204 detects whether the external device (TV receiver 100) is connected to the mobile phone 200 (S3). If it is not detected that the TV receiver is connected to the mobile phone 200 (No at S3), the process flows back to S1 so that the display screen in accordance with the orientation of the mobile phone 200 is kept displayed on the display 202.

On the other hand, if it is detected that the TV receiver 100 is connected to the mobile phone 200 (Yes at S3), the controller 204 acquires model information (such as model number) indicating a model of the mobile phone 200 from various information preliminarily set in the memory 205. Then, the controller 204 outputs the acquired model information to the TV receiver 100 via the communication IF 210 and the communication cable 300 (S4). Next, the controller 204 displays an operation image corresponding to the orientation of the mobile phone 200 detected by the orientation detector 209 on the screen of the display 202 (S5).

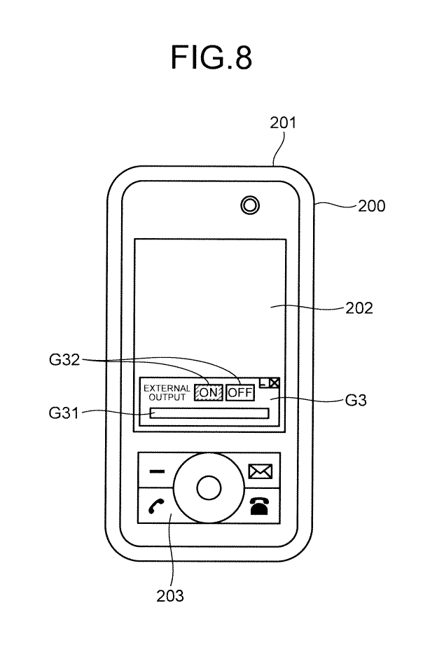

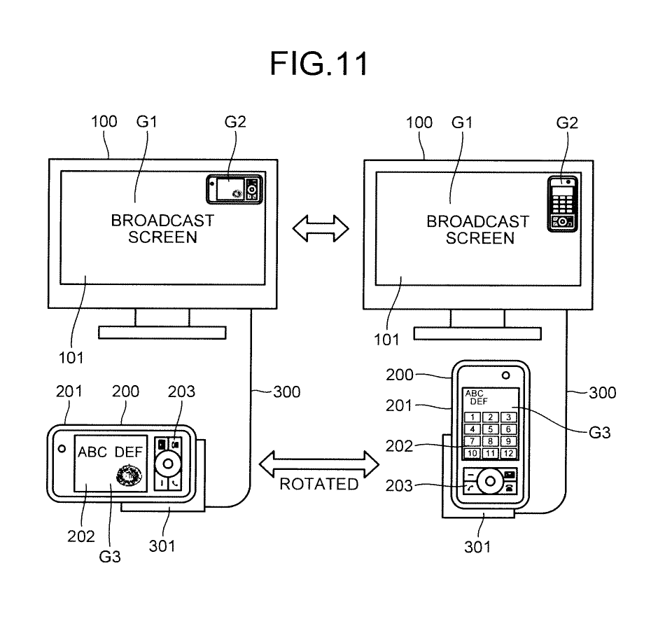

The operation image of S5 is an image such as an icon image for operation instruction with respect to the connected TV receiver 100. FIG. 8 is a conceptual diagram illustrating one example of an operation image G3. As illustrated in FIG. 8, the operation image G3 is displayed on the screen of the display 202 at an orientation coinciding with the orientation of the display 202 detected by the orientation detector 209. Here, the orientation detector 209 detects whether the display 202 is oriented upward (standard orientation), rightward, leftward, or the downward, with reference to the standard orientation of the display 202 in which the operation module 203 is placed below the display 202 in the direction of gravity. In the illustrated example, the operation image G3 has an orientation adapted to the orientation of the mobile phone 200 in which the operation module 203 is placed at the bottom, so that the operation image G3 is displayed at the bottom of the screen of the display 202. The operation image G3 comprises a slider G31 and a button G32. The slider G31 is for adjusting a ratio between a size of a screen G1 and an external input screen G2 when the screen G1 and the external input screen G2 are simultaneously displayed in a dual display mode. The button G32 is for the operation to turn on/off the external input screen G2. The configuration of the operation image G3 can be changed in accordance with the orientation of the mobile phone 200 detected by the orientation detector 209. For example, an operation button for changing a channel of a broadcast screen which has been displayed on the screen G1 can be displayed when the orientation is not the vertical described above but the horizontal (see FIG. 11).

The controller 204 as the output module outputs display data which has been displayed on the screen of the display 202 and the information (orientation information) of the orientation of the mobile phone 200 detected by the orientation detector 209, to the TV receiver 100 via the communication IF 210 and the communication cable 300 (S6). The information on the orientation can be information on whether the display 202 is oriented upward (standard orientation), rightward, leftward, or downward, with reference to the orientation in which the operation module 203 is placed at the bottom (the vertical mode in FIG. 4) in the direction of gravity.

Then, the controller 204 receives the operation instruction of the operation image G3 displayed on the screen of the display 202, from the operation module 203 (S7). The operation of the operation image G3 can be received through an operation button or a touch panel placed on the display 202. Next, the controller 204 outputs the received operation instruction to the TV receiver 100 via the communication IF 210 and the communication cable 300 (S8).

Then, the controller 204 determines whether to end the process in response to the operation instruction for finishing the process from the operation module 203, in response to when the mobile phone 200 placed in the cradle 301 is removed, or the like (S9). The process flows back to S1 when the process is to be continued (No at S9). On the other hand, when the process is to be finished (Yes at S9), the controller 204 stops displaying the display screen on the display 202, stops outputting the display data to the TV receiver 100, or the like, and finishes the process.

The operations of the TV receiver 100 are explained next. The process of the TV receiver 100 described below is realized for example when the controller 102 sequentially executes the application 1031 based on the operation instruction from a remote controller, an operation button, or the like, not illustrated.

As illustrated in FIG. 7, when the process starts, the controller 102 displays the content contained in the broadcast wave received by the tuner 104, on the broadcast screen of the display 101 (S20). In the present embodiment, in addition to the display screen output from the mobile phone 200, the broadcast screen is illustrated as the display from the TV receiver 100. However, the display screen of the TV receiver 100 may include a program guide, content input from a recorder or the like, and/or the like, other than the broadcast screen.

Next, the controller 102 detects whether the external device (mobile phone 200) is connected to the TV receiver 100 (S21). If the mobile phone 200 is not connected to the TV receiver 100 (No at S21), the process flows back to S20. Accordingly, the displaying of the broadcast screen on the display 101 is continued.

On the other hand, if the mobile phone 200 is connected to the TV receiver (Yes at S21), the controller 102 receives the model information output by the mobile phone 200 through the communication cable 300 and the communication IF 106 (S22). Then, the controller 102 receives the display data and the orientation information of the mobile phone 200 output by the mobile phone 200 via the communication cable 300 and the communication IF 106 (S23).

Next, the controller 102 starts the dual screen display. In the dual screen display, the display 101 displays the screen G1 and the external input screen G2 (S24). The screen G1 displays the broadcast screen which had been displayed before the mobile phone 200 is connected to the TV receiver 100. The external input screen G2 displays the display data received from the mobile phone 200.

When the dual screen display is started, the controller 102 sets a frame for the external input screen G2 in accordance with the model information received from the mobile phone 200 (S25). In particular, the controller 102 refers to frame images each of which is preliminarily set for each model in the various information of the memory 205. Then, the controller 102 sets an image frame corresponding to a model indicated by the received model information as the frame for the external input screen G2.

Next, the controller 102 places and fits the video of the display data received from the mobile phone 200, or namely, the display screen of the display 202, within the frame set by S25, and generates the external input screen G2 (S26). Then, the controller 102 as an image rotating module rotates the generated external input screen G2 based on the information indicating the orientation of the mobile phone 200 received from the mobile phone 200 (S27), and displays the rotated external input screen G2 on the display 101. In particular, the external input screen G2 is rotated in a direction toward which the external input screen G2 is adapted to the orientation of the mobile phone 200, and displays the rotated external input screen G2 on the display 101.

For example, when the display 202 is oriented upward (vertical mode in FIG. 4), the external input screen G2 is rotated to the display orientation adapted to the orientation of the mobile phone 200 in which the operation module 203 is located below the display 202, and displays the rotated external input screen G2. When the mobile phone 200 is rotated 90 degrees toward left (in the horizontal mode) so that the display 202 is oriented rightward with respect to the standard orientation, the external input screen G2 is rotated to the display direction adapted to the orientation of the mobile phone 200 in which the operation module 203 is located at the right hand side of the display 202, and displays the rotated external input screen G2. As mentioned above, the external input screen G2 displaying the display screen of the mobile phone 200 is rotated to be adapted to the orientation of the mobile phone 200. Hence, the display of the external input screen G2 can be prevented from being displayed sideway, thereby it becomes easier to see the external input screen G2.

Next, the controller 102 receives the operation instruction output by the mobile phone 200 through the communication cable 300 and the communication IF 106 (S28). Then, the controller 102 changes the display of the display 101 in accordance with the received operation instruction (S29). For example, in S29, the display sizes of the screen G1 and the external input screen G2 displayed on the display 101 is changed according to a ratio between a size of the screen G1 and a size of the external input screen G2 (size information) instructed by the slider G31 (see FIG. 8). Further, in S29, when it is instructed to change the channel of the broadcast screen currently displayed on the screen G1, the display of the screen G1 is changed to a video of a channel corresponding to the instruction. Here, the changing of the display size of the external input screen G2 based on the ratio of the sizes is only an example, and the display size of the external input screen G2 can be changed based on a number of pixels indicating an actual size.

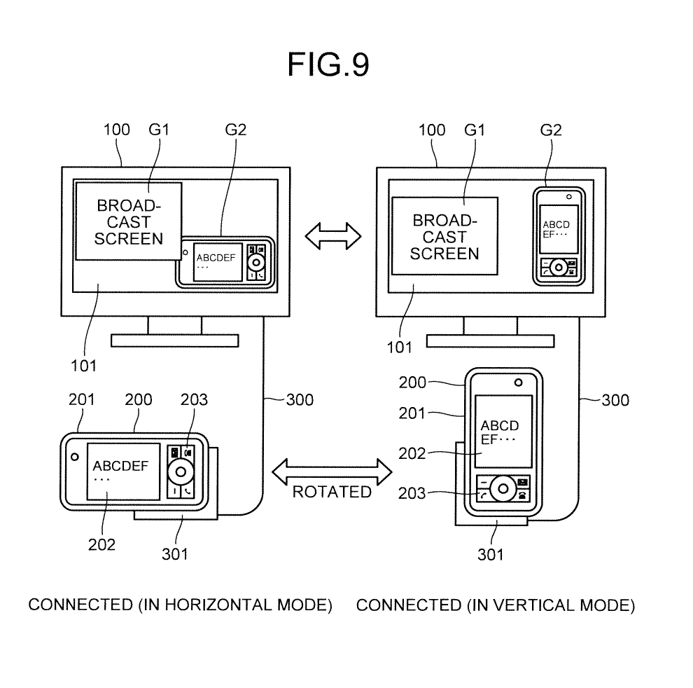

Depending on the amount of change in the display size, the screen G1 and/or the external input screen G2 may not fit within the display area of the display 101 when the screen G1 and the external input screen G2 are placed vertically or horizontally. For example, as illustrated in FIG. 9, when the screen G1 and the external input screen G2 are arranged horizontally and the orientation of the mobile phone 200 is changed to the vertical mode, the screen G1 and the external input screen G2 do not fit within the display area of the display 101. In this case, as illustrated in FIG. 9, the screen G1 and the external input screen G2 may be overlapped and displayed. On the other hand, a portion of one of the screen G1 and the external input screen G2 can be placed outside of the display area of the display 101. In this case, it is preferred that the portion placed outside of the display area is only the frame image of the external input screen G2.

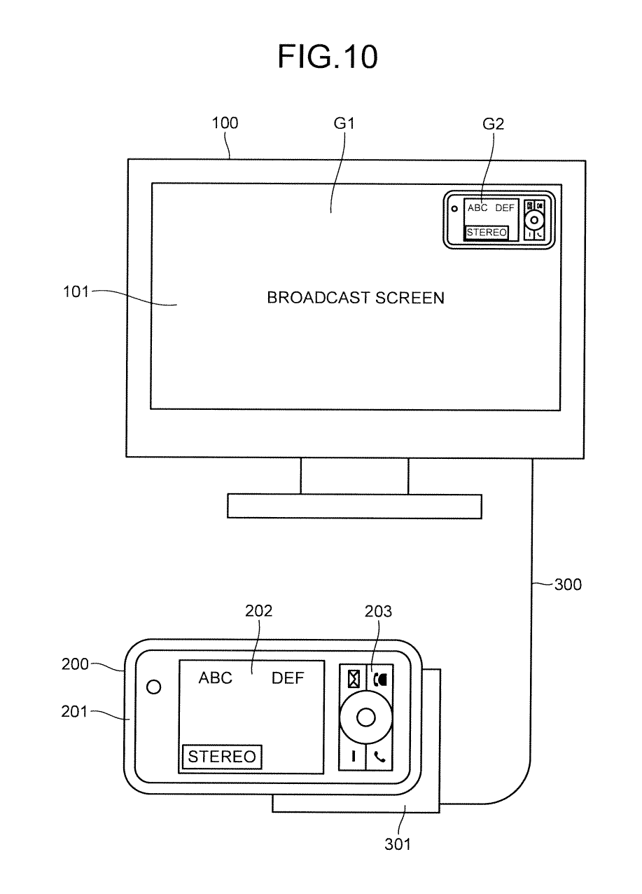

The layout of the dual screen display of the screen G1 and the external input screen G2 is not limited to that of FIGS. 4 and 9. For example, there may be a case where the screen displaying the broadcast screen is set as a main screen, and the broadcast screen is operated via the operation image G3 displayed on the display 202 of the mobile phone 200. In this case, as illustrated in FIG. 10, the screen G1 may be displayed over the entire display area of the display 101, and the external input screen G2 may be displayed at a corner of the display area. By such layout, the external input screen G2 can be made less visible, as similar to the display of the channel on the broadcast screen.

As illustrated in FIG. 11, when the broadcast screen is operated via the operation image G3 displayed on the display 202 of the mobile phone 200, the configuration of the operation image G3 of the display 202 can be changed corresponding to the orientation of the mobile phone 200. In particular, as illustrated in FIG. 11, the operation image G3 can be changed between an operation image G3 in horizontal mode and an operation image G3 in vertical mode, according to the rotation. In this case, in response to changing the operation image G3, the display of the external input screen G2 is changed.

Referring back to FIG. 7, the process of the TV receiver 100 after S29 is explained. Subsequent to S29, the controller 102 determines whether the mobile phone 200 is disconnected from the TV receiver 100 (S30). If it is determined that the mobile phone 200 is not disconnected from the TV receiver 100 (No at S30), the process flows back to S25 and the displaying of the dual screen display is continued.

On the other hand, if it is determined that the mobile phone 200 is disconnected from the TV receiver 100 (Yes at S30), the controller 102 ends the displaying of the external input screen G2 on the display 101 (S31) so that only the broadcast screen is displayed as before. Similarly, when there is an instruction to turn off the display of the external input screen G2 via the button G32 of the operation image G3 or the like, the displaying of the external input screen G2 on the display 101 is finished so that only the broadcast screen is displayed as before.

Next, the controller 102 determines whether to end the process in response to the operation instruction via the remote controller, the operation button, or the like (S32). If the process is to be continued (No at S32), the process flows back to S20. On the other hand, if the process is to be finished (Yes at S32), the controller 102 stops the displaying of the broadcast screen on the display 101, and finishes the process.

As described above, the TV receiver 100 receives the display data including the display screen to be displayed in the orientation in accordance with the orientation of the mobile phone 200 and the information indicating the orientation of the mobile phone 200. Then, based on the information of the orientation of the mobile phone 200, the TV receiver 100 rotates the display screen contained in the display data in a direction toward which the orientation of the display screen is adapted to the orientation of the mobile phone 200. Subsequently, the TV receiver 100 displays the rotated display screen on the display 101 as the external input screen G2. Therefore, the TV receiver 100 can make the display screen output from the mobile phone 200 and changed in accordance with the orientation easier to see.

In the aforementioned embodiment, the entire display screen of the display 202 is displayed on the display 101 as the external input screen G2. However, the area to be displayed as the external input screen G2 is not limited to the entire display screen of the display 202, but can be a portion of the display screen. For example, when a resolution of the display 202 is sufficiently high in comparison to a resolution of the display 101, an area of the external input screen G2 occupying the display 101 becomes large. Thus, in this case, it is preferred to display a portion of the display screen of the display 202 as the external input screen G2.

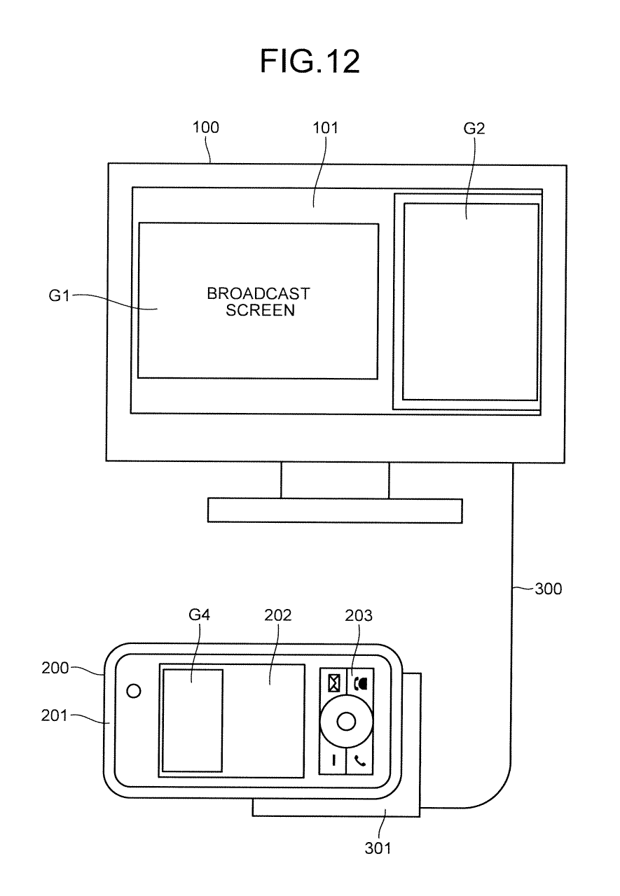

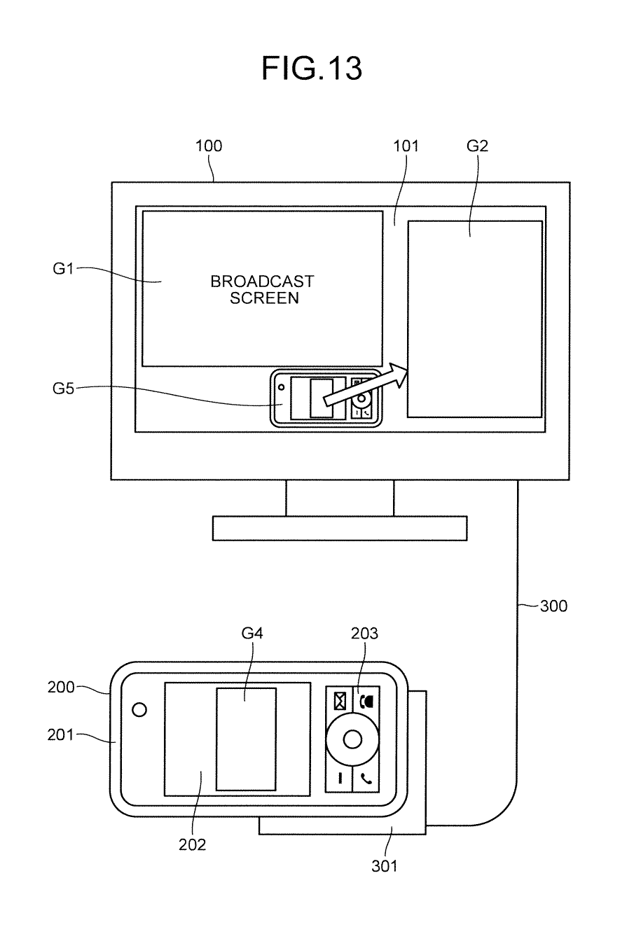

FIGS. 12 and 13 are conceptual diagrams illustrating display of the TV receiver 100 and the mobile phone 200 according to a modification. As illustrated in FIGS. 12 and 13, in the modification, the external input screen G2 displays thereon a display screen of the display 202 selected by a display area icon G4 corresponding to the operation of the operation module 203 or the like.

Process according to the modification is explained. In the process at the mobile phone 200 according to the modification, selection of an area is received via the display area icon G4 (corresponding to S7 of FIG. 7). Then, information on a size and a position of the received area is output to the TV receiver 100 (corresponding to S8 of FIG. 7). At the TV receiver 100, the information on the size and position of the area is received (corresponding to S28 of FIG. 7). Next, an image is trimmed from the external input screen G2 rotated at S27, based on the received information. Then, the image is displayed on the display 101 (corresponding to S29 of FIG. 7).

As described above, when the area of the portion of the display screen of the display 202 is displayed as the external input screen G2, it is difficult to determine which area of the display screen of the display 202 is displayed from the display of the display 101. Thus, as illustrated in FIG. 13, at the TV receiver 100, the display 101 displays an external device icon G5 which is based on the information indicating the size and the position of the area displayed as the external input screen G2. Consequently, it becomes capable of determining, from the external device icon G5, which area of the display screen of the display 202 is displayed as the external input screen G2.

A program executed by the TV receiver 100 and the mobile phone 200 of the embodiment are preliminarily stored in the ROM or the like, and provided. The program may be stored in a storage medium capable of being read by a computer, such as a compact disk read only memory (CD-ROM), a flexible disk (FD), a compact disk recordable (CD-R), a digital versatile disk (DVD), or the like, and provided.

Furthermore, the program may be stored in a computer connected to a network such as the Internet, and may be downloaded via the network. Still further, the program may be provided or distributed via the network such as the Internet.

The program executed by the TV receiver 100 and the mobile phone 200 of the embodiment has a module configuration comprising function modules corresponding to the process of S1 to S32 described above. As an actual hardware, the CPU (processor) loads the program from the ROM, and executes the program. Accordingly, the aforementioned functional modules are loaded and generated on a main memory.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display device comprising:
a receiver configured to receive display data and orientation information from an external device connected to the display device, the display data comprising a display screen to be displayed in an orientation according to an orientation of the external device, the orientation information indicating the orientation of the external device;
an image rotating module configured to rotate the display screen contained in the display data in a direction toward which the display screen is adapted to the orientation of the external device based on the orientation information; and
a display module configured to display the display screen rotated by the image rotating module.

2. The display device of claim 1, wherein
the receiver is configured to receive model information on a model of the external device from the external device connected to the display device,
the image rotating module is configured to rotate an image in the direction toward which the image is adapted to the orientation of the external device, the image comprising the display screen embedded in a frame image corresponding to the model information, and
the display module is configured to display the image rotated by the image rotating module.

3. The display device of claim 1, further comprising a detector configured to detect whether the external device is connected to the display device, wherein
the display module is configured to display a first screen and a second screen if it is detected that the external device is connected to the display device, the first screen being a screen displayed before it is detected that the external device is connected to the display device, the second screen comprising the display screen rotated by the image rotating module.

4. The display device of claim 3, wherein
the receiver is configured to receive size information on a display size of the second screen from the external device connected to the display device, and
the display module is configured to display the second screen with the display size of the size information.

5. The display device of claim 1, wherein
the receiver is configured to receive area information on an area to be displayed of the display screen from the external device connected to the display device, and
the display module is configured to display an image corresponding to an area cropped out from the display screen rotated by the image rotating module, the cropped out area corresponding to the area information.

6. An information terminal device comprising:
an orientation detector configured to detect an orientation of the information terminal device;
a display module configured to display a screen in an orientation adapted to the orientation detected by the orientation detector; and
an output module configured to output display data and orientation information to an external device connected to the information terminal device, the display data comprising the screen displayed by the display module, the orientation information indicating the orientation detected by the orientation detector.

7. The information terminal device of claim 6, further comprising a detector configured to detect whether the external device is connected to the information terminal device, wherein
the output module is configured to start outputting the display data and the orientation information if it is detected that the external device is connected to the information terminal device.

8. A display method comprising:
receiving, by a receiver, display data and orientation information from an external device, the display data comprising a display screen to be displayed in an orientation according to an orientation of the external device,
rotating, by an image rotating module, the display screen contained in the display data in a direction toward which the display screen is adapted to the orientation of the external device based on the orientation information; and
displaying, by a display module, the display screen rotated at the rotating.
